(19) United States
(12) Patent Application Publication
(10) Pub. No.: US 2021/0364053 A1
(43) Pub. Date: Nov. 25, 2021

(54) THERMAL MANAGEMENT OF METAL MATRIX COMPOSITE SYSTEMS

(71) Applicant: Intellectual Property Holdings, LLC, Cleveland, OH (US)

(72) Inventors: Ryan G. Sarkisian, Cleveland, OH (US); Jake Schurr, Fairview Park, OH (US); Andrew Dorman, Cleveland, OH (US); Dan T. Moore, Cleveland Heights, OH (US)

(21) Appl. No.: 17/327,632

(22) Filed: May 21, 2021

Related U.S. Application Data
(60) Provisional application No. 63/122,882, filed on Dec. 8, 2020.
(60) Provisional application No. 63/029,332, filed on May 22, 2020.

(51) Int. Cl. F16D 65/12; F16D 69/02

(52) U.S. Cl. CPC F16D 65/125; F16D 2069/005; F16D 69/028; F16D 65/127

(57) ABSTRACT

The present application discloses a high-performance metal matrix composite (MMC) vehicle braking component, two methods of making a porous ceramic insert, a method of making an MMC comprising a porous ceramic insert, and a method of making an MMC not comprised of a porous ceramic insert. In one exemplary embodiment the porous ceramic insert is comprised of a ceramic compound and a sacrificial insert. In another exemplary embodiment the porous ceramic insert is comprised of one or more ceramic compounds and one or more ceramic preforms. The high performance MMC vehicle braking component has two distinct friction portions that extended from the outer surfaces to the thermal management portion of the high performance MMC vehicle braking component.

### TECHNICAL FIELD

The present application relates generally to composite brake components and methods of making the same, and more specifically to metal matrix composite brake components and methods of making metal matrix composite brake components.

### BACKGROUND OF THE INVENTION

A metal matrix composite (MMC) is a material that is composed of two or more components, which are combined in order to improve the material properties over the individual components' properties. Generally, MMCs are made by incorporating a reinforcing ceramic material into a metal matrix. For example, an MMC may comprise a porous ceramic insert that is infiltrated with a metal. An MMC generally has properties and physical characteristics different from monolithic metal that may be desirable depending on the application. Relative to the metal surrounding an MMC, the MMC may have a higher specific strength, a higher Young's modulus, higher temperature resistance, higher transverse stiffness and strength, higher resistance to moisture absorption, higher electrical and thermal conductivity, lower density, and higher hardness which results in higher wear resistance. The particular physical properties of MMCs are often dependent on the final application and may be modified by changes in both the matrix and metal alloy used.

Internal combustion engine (ICE) vehicles or battery electric vehicles (BEV) often include disc brakes. A brake system generally comprises a rotating braking component—i.e., the rotor or disc—and a brake caliper assembly. The caliper assembly has brake pads that squeeze the inboard and outboard surfaces of the brake rotor or disc to create a frictional force, thereby generating a retarding torque which reduces the speed of the vehicle by converting the vehicle's kinetic energy into heat via friction. During the braking process, there is often a high energy transfer to the friction surfaces of the brake rotor which can lead to a rise in temperature of these components.

### SUMMARY

The present application discloses a method of making exemplary ceramic preforms and MMC braking components incorporating the same to form MMC braking components having at least two friction or braking surfaces spaced apart by a thermal management portion that is formed from monolithic metal portions and in some cases MMC portions.

### BRIEF DESCRIPTION OF THE DRAWINGS

These and other features and advantages of the present invention will become better understood with regard to the following description and accompanying drawings in which:

FIG. 1 shows a perspective view of an exemplary MMC braking component;

FIG. 2 shows a cross-sectional view of the MMC braking component of FIG. 1 taken along the line 1-1;

FIG. 3 shows the steps of an exemplary method of making an MMC braking component using a ceramic preform;

FIG. 4 shows the steps of an exemplary method of making an MMC braking component using a slurry of molten metal and ceramic particles;

FIG. 5 shows the steps of an exemplary method of casting an MMC braking component using a ceramic preform with integral spacers;

FIG. 6 shows the steps of an exemplary method of forming a ceramic perform with integral spacers;

FIG. 7 shows the steps of an exemplary method of casting an MMC braking component using a plurality of spacers between two ceramic preforms;

FIG. 8 shows illustrations of a portion of an exemplary braking component in various stages of an exemplary method of making a ceramic preform and an MMC braking component;

FIG. 9 shows the steps of an exemplary method of casting an MMC braking component using a casting mold with more than one locating surface;

FIGS. 10 and 11 shows the steps of an exemplary method of casting an MMC braking component using a sacrificial insert;

FIG. 12 shows the steps of an exemplary method of making a ceramic perform including a sacrificial insert;

FIG. 13 shows the steps of an exemplary method of making an MMC braking component with a preform including a sacrificial insert;

FIG. 14 shows illustrations of a portion of an exemplary braking component in various stages of an exemplary method of making a ceramic preform and an MMC braking component;

FIG. 15-18 show the steps of exemplary methods of making a sacrificial insert;

FIGS. 19-22 show exemplary sacrificial inserts for use in forming preforms or for use in the casting process;

FIGS. 23 and 24 shows the steps of an exemplary method of casting an MMC braking component with a preform including more than one ceramic compound;

FIG. 25 shows illustrations of a portion of an exemplary braking component in various stages of an exemplary method of making a ceramic preform and an MMC braking component;

FIG. 26 shows an isometric view of an exemplary two-piece MMC braking component;

FIG. 27 shows an isometric view of an exemplary hub portion of the two-piece MMC braking component;

FIG. 28 shows an isometric view of an exemplary disc portion of the two-piece MMC braking component;

FIG. 29 shows a cross-sectional view of a first ceramic preform placed a first locating surface of an exemplary mold;

FIG. 30 shows a cross-sectional perspective view of the ceramic preform and mold of FIG. 29;

FIG. 31 shows a cross-sectional view of a second ceramic preform placed a second locating surface of an exemplary mold;

FIG. 32 shows a cross-sectional perspective view of the ceramic preforms and mold of FIG. 29;

FIG. 33 shows a cross-sectional view of a the preforms and mold of FIGS. 31-32 with the mold closed;

FIG. 34 shows a cross-sectional perspective view of the ceramic preforms and mold of FIG. 33;

FIG. 35 shows a cross-sectional view of the ceramic preforms and mold of FIGS. 33-34 filled with casting alloy;

FIG. 36 shows a cross-sectional perspective view of the ceramic preforms and mold of FIG. 33;

FIG. 37 shows a perspective view of an exemplary cast braking component removed from the mold of FIGS. 35-36;

FIG. 38 shows a cross-sectional perspective view of the exemplary cast braking component of FIG. 37;

FIG. 39 shows a perspective view of the exemplary cast braking component of FIGS. 37-38 machined to final dimensions; and

FIG. 40 shows a cross-sectional perspective view of the exemplary cast braking component of FIG. 39.

### DETAILED DESCRIPTION

As described herein, when one or more components are described as being connected, joined, affixed, coupled, attached, or otherwise interconnected, such interconnection may be direct as between the components or may be indirect such as through the use of one or more intermediary components. Also as described herein, reference to a “member,” “component,” or “portion” shall not be limited to a single structural member, component, or element but can include an assembly of components, members, or elements. Also as described herein, the terms “substantially” and “about” are defined as at least close to (and includes) a given value or state.

Metal matrix composites (MMC) with a lightweight metal alloy, such as aluminum, have been utilized in multiple industries due to their advantageous and customizable properties. These industries include; aerospace, automotive, heavy truck, defense, mining, and specialty materials. MMCs with selectively placed enhancement allow for the flexibility of enhancement on the required surfaces while allowing the remainder of the component to be lightweight and structurally sound for each application. The potential applications for MMCs can include, but are not limited to, vehicle body components, frame components, vehicle suspension and knuckle components, and components of braking systems. These applications require lightweight components that retain or improve upon the durability, strength, wear resistance, corrosion resistance, and other measures relative to existing vehicle components while also dissipating heat generated during a breaking operation.

In many vehicles, braking components are generally composed of cast iron. While cast iron has great rigidity and thermal properties that are helpful in managing a braking load, cast iron also has a high density, resulting in very heavy components. With the current trend in the automotive market moving towards Battery Electric Vehicles (BEV), also comes the desire of the automotive market to move toward more lightweight materials. The reason for this correlation, is that a main drawback to BEV is the inability to quickly recharge once the battery is depleted. In order to account for this drawback, a main selling point for a BEV is the vehicles range, i.e., how many miles the vehicle can travel on one charge. One conventional way to improve the range of a BEV is to decrease the weight of components on the vehicle, specifically the un-sprung weight. In order to decrease the weight an aluminum metal matrix composite material may be used, as is described herein.

An MMC is fabricated generally through adding a reinforcement or enhancement to a metal alloy, thereby tailoring the resulting composite material to meet a goal performance objective with relation to one or more specific material properties. MMCs can be produce through either a preform method or stir casting method. The preforming method is a procedure of creating a porous, inorganic, non-metallic insert that can be impregnated with molten metal during a casting operation—normally a squeeze casting or high pressure die casting operation. The stir-cast method is a process in which an inorganic, non-metallic component is mixed into a crucible of molten alloy and pressure cast into a defined geometry.

Aluminum Metal Metrix Composites (Al-MMCs) have a lower maximum operating temperature when compared to cast iron braking components. This lower maximum operating temperature is a result of the material properties of the metal matrix or alloy choice, for example, the melting point of aluminum is lower than the melting point of iron. A limited maximum operating temperature can limit the use of an MMC vehicle braking component to lower performance vehicles, rear axle applications, and/or light weight vehicles. The low weight, corrosion resistance, and wear resistance properties of Al-MMCs are well suited to brake rotor or disc applications and provide an improvement over cast iron braking components. To take advantage of these features of Al-MMC braking components, the heat generated during breaking must be transferred out of the Al-MMC braking component to maintain the temperature of the Al-MMC braking component below the maximum operating temperature. This thermal management is particularly important when designing an Al-MMC braking component to replace a cast iron breaking component with a higher maximum operating temperature.

The present application discloses a metal matrix composite braking component—and processes for making the same—that has selectively placed enhancement and monolithic metal portions to create an improved thermal management system so that heat generated during braking is sufficiently transferred away from the MMC portion to maintain the MMC portion below its maximum operating temperature.

The braking components and processes described herein use ceramic preform, recast, or stir-cast techniques to selectively place the ceramic material in select locations in the final part, thereby providing an increase in thermal conductivity of the monolithic alloy to remove heat from the braking surface at an accelerated rate. The metal alloys utilized in exemplary MMCs disclosed herein comprise aluminum, magnesium, titanium, and copper.

Exemplary methods of making a ceramic preform include steps of:

preparing a ceramic compound having reinforcing fibers, ceramic particles, a high temperature binder, and an organic pore former; providing ceramic compound to a mold cavity so that the mold partially fills to a first height with ceramic compound; providing a sacrificial molding core that is placed into the mold cavity on top of the existing ceramic compound; providing additional ceramic compound to the mold cavity which rests on top of the sacrificial molding core up to a final fill height; and applying heat and pressure to the ceramic compound and sacrificial molding core. The first layer of the ceramic preform that is formed according to the present embodiment is comprised of solely ceramic compound and represents the first friction surface of the ceramic preform once fired and cast. The second layer of the ceramic preform is comprised of a sacrificial molding core as well as ceramic compound, this layer represents the thermal management portion of the ceramic preform once fired and cast. The third layer of the ceramic preform is comprised of solely ceramic compound and represents the second friction surface of the ceramic preform once fired and cast. The preforming tool containing first ceramic compound is then closed to form a mold cavity. After the formation of a mold cavity, the mold cavity is pressurized up to a preforming pressure of about 1,000 psi to about 3,000 psi, heated up to a preforming temperature of about 250° F. to about 350° F., and held for a preforming time of about 30 seconds to about 5 minutes.

Another exemplary method of making a ceramic preform includes steps of: preparing a first ceramic compound having ceramic particles, reinforcing fibers, a high temperature binder, and an organic pore former; preparing a second ceramic compound having ceramic particles, reinforcing fibers, a high temperature binder, and an organic pore former having a particle size larger than that of the pore former in the first ceramic compound; providing first ceramic compound to a preforming mold up to a first fill height; providing second ceramic compound into the preforming mold on top of the first ceramic compound up to a second fill height; providing first ceramic compound to the preforming mold on top of the second ceramic compound up to a final fill height; and applying heat and pressure to the preforming mold containing the first and second ceramic compound in order to form an integrally formed ceramic preform. The resulting ceramic preform includes first and second friction surfaces that are formed from the first ceramic compound while the thermal management portion sandwiched between the friction surface portions is formed from the second ceramic compound.

Still another exemplary method of making a ceramic preform includes: preparing a ceramic compound having ceramic particles, reinforcing fibers, a high temperature binder, and an organic pore former; providing ceramic compound to a preforming mold, which may contain stilts; and pressurizing and heating the preforming mold containing ceramic compound to form an integrally formed ceramic preform.

An exemplary MMC braking component, such as an MMC brake disc, of the present disclosure relates to a method of making a MMC brake disc having a thermal management portion that is sandwiched between first and second MMC portions for generating friction with the brake calipers, the method including: forming one or more ceramic preforms which may contain a sacrificial molding core or spacers; firing the ceramic preforms to burn out the organic components and to vitrify the ceramic particles and reinforcing fibers; placing one or more fired ceramic preforms into a squeeze casting mold, which may contain an inorganic core, resulting in a porous ceramic insert; forming an MMC brake component by infiltrating the porous ceramic insert with molten casting metal to form a MMC brake disc with portions composed of monolithic casting material (e.g., aluminum) and portions composed of MMC. The MMC portions are arranged at the braking or friction surfaces so that the portion of the brake that is engaged during breaking is entirely formed of MMC material and the thermal management portion is mostly composed of monolithic casting alloy.

Still another exemplary embodiment of the present disclosure relates to a method for making an MMC vehicle brake component having localized metal matrix composite portions, the method including: forming a homogenous ceramic and molten metal slurry that is composed of a casting alloy and ceramic particles; providing the homogenous ceramic and molten metal slurry to a mold; forming a first MMC vehicle component by pressurizing the mold containing the homogenous ceramic and molten metal slurry to a forming pressure; forming a second MMC vehicle component by providing the homogenous ceramic and molten metal slurry to a mold and pressurizing the mold containing the homogenous ceramic particle and molten metal slurry to a forming pressure; providing the first and second MMC vehicle components to a squeeze casting mold; providing monolithic casting alloy to the mold; pressurizing the first and second MMC vehicle components and the monolithic casting alloy to a forming pressure.

Due to the lightweight casting alloys' thermal expansion properties and the thermal gradient developed between the disc and hub, large amounts of stress are concentrated at the connection point between the disc and hub portion of the single piece braking system. These stresses are further increased within the brake disc as the diameter of the disc increases. A two-piece design greatly reduces the stress observed at the connection point between the hub and disc of a brake component because a two-piece assembly does not constrict the radial growth of the disc with respect to the hat or hub, thereby mitigating the stresses observed due to the thermal gradient developed between the hub and disc during a braking event.

Another embodiment of the invention reduces the stresses that are imposed due to the comparatively high thermal expansion of the lightweight casting metal. It is well known in relevant industries that automotive braking components are traditionally composed of cast iron. Substituting the cast iron material for a lightweight casting alloy, such as aluminum, would result in more thermal expansion than its cast iron counterpart. To reduce the impact of the increased thermal expansion of the aluminum component (e.g., an MMC component), the braking component can be formed in two parts. That is, the heat generated during braking and the resulting thermal expansion can be isolated to one portion of the braking component to reduce thermal stress experienced by other components. For example, an MMC braking component can be formed in two pieces that are rotationally coupled and allow the friction surfaces to move during thermal expansion without transmitting stress from the expansion onto other portions of the MMC braking component. These two-piece MMC braking components are suitable for high torque braking applications, such as on vehicles that have higher gross vehicle weight ratings (GVWR).

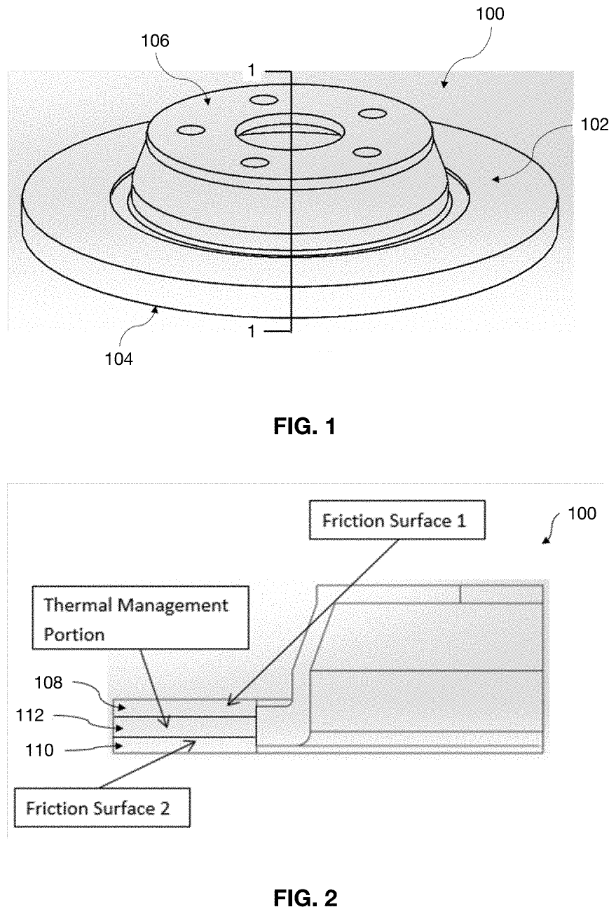

Now referring to FIGS. 1 and 2, an isometric depiction of an exemplary MMC vehicle braking component 100 is shown. The outer diameter of the MMC vehicle braking component 100 is about 10 to 20 inches. The MMC vehicle braking component 100 has two outer wear portions 108 and 110. The MMC vehicle braking component 100 has a thickness between the outer surfaces of the wear portions 108 and 110 of about 0.5 to 2.5 inches. The MMC vehicle braking component 100 is connected to and rotates with a wheel of a vehicle through a hub mounting portion 106 which is composed of monolithic casting metal (e.g., aluminum). Along with this, a brake caliper (not shown) is actuated to apply pressure against the outer wear surfaces of the wear portions 108, 110 and thereby generate a retarding torque due to friction to slow down and stop the MMC vehicle braking component 100 which is connected to the wheel (not shown) via the hub mounting portion 106. The friction force that is generated by the interaction between the brake caliper pads (not shown) and the outer wear portions 106, 110 results in a large amount of kinetic energy being converted to heat energy within in the MMC vehicle braking component 100.

Referring now to FIG. 2, a cross sectional view of the MMC vehicle braking component 100 is shown taken at the parting line 2-2 shown in FIG. 1. In this view, the two wear or friction portions 108 and 110 are shown separated by a thermal management portion 112. The thickness of the wear or friction portions 108 and 110 is measured between the outer most surface of the wear or friction portions 108 and 110 and the outer most surfaces of the thermal management portion 112 and is about 0.125 inches to about 1.5 inches. The wear or friction portions 108 and 110 are comprised of entirely MMC material. The thermal management portion 112 can be formed of solid monolithic casting alloy, a combination of solid casting alloy and MMC, a vented MMC portion, or vented monolithic casting alloy portion. The thermal management portion 112 has a thickness of about 0.080 inches to about 1.5 inches. The purpose of the thermal management portion 112 is to act as a heat sink for the large amount of heat energy that is generated by friction with the wear or friction portions 108, 110 during a braking event. The purpose of the thermal management portion 112 is to quickly reduce the high temperatures developed on the friction surface during a high-power braking event by conducting heat away from the friction surface of the wear or friction portions 108, 110 and into the thermal management portion 112. The thermal management portion 112 can also be used to store the heat energy via a thermal mass and to dissipate the energy via venting. After the heat energy is transferred into the thermal management portion 112, the heat can then transfer from the thermal management portion 112 to the hub mounting portion 106 and then through the hub (not shown) and into the axel of the vehicle (not shown). The heat energy being wicked away from both of the wear or friction portions 108 and 110 allows the MMC braking component to withstand high power stops under high loading conditions.

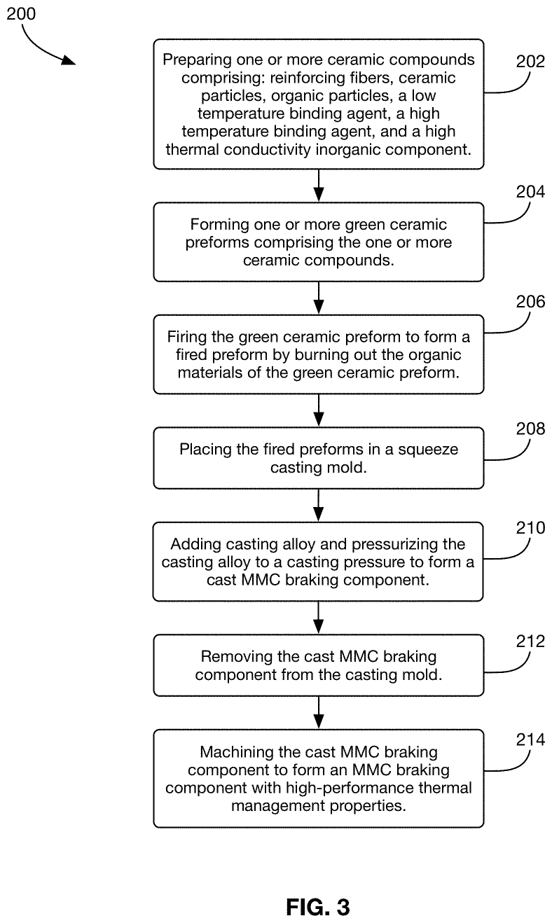

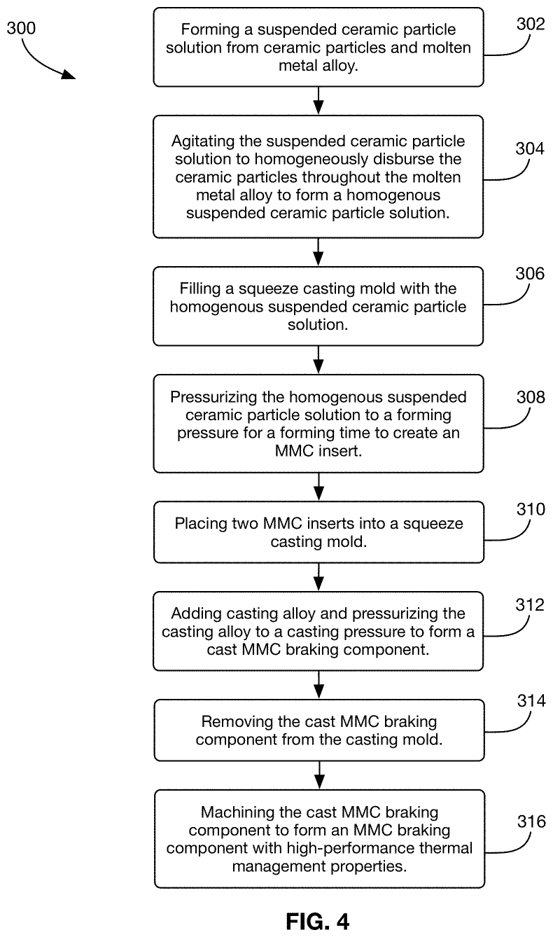

Referring now to FIGS. 3 and 4, exemplary methods for the creation of a metal matrix composite vehicle braking component are shown. Two exemplary techniques for making a metal matrix composite vehicle braking component are shown. The first technique, embodied in the method of FIG. 3, involves forming a ceramic preform that is then combined with a molten casting alloy to form an MMC vehicle braking component. The second technique involves the mixing of ceramic particles into a molten metal alloy solution to cast an MMC vehicle braking component including MMC portions.

Referring now to FIG. 3, the steps of a method 200 for making an MMC braking component using a ceramic preform is shown. The method 200 begins with preparing one or more ceramic compounds (step 202) made from ingredients that can include reinforcing fibers, ceramic particles, organic particles, a low temperature binding agent, a high temperature binding agent, and a high thermal conductivity inorganic component. For example, in one particular embodiment the ceramic compound includes: ceramic particles at about 35-45 wt. %, reinforcing fibers at about 9-14 wt. %, sacrificial organic particles at about 15-35 wt. %, and in some cases a high thermal conductivity inorganic component at about 1-5 wt. %. The ceramic compound can optionally include a high temperature binder and a low temperature binder to improve handling of the ceramic preform in a production setting. The ceramic compound is then formed into a ceramic preform (step 204) using a preforming mold that is filled up to a final fill height, such as, for example, a final fill height of about 1 inch to about 6 inches. The filled preforming mold is then heated to a preforming temperature of about 200° F. to about 300° F. and is pressurized to a preforming pressure of about 1,000 psi to about 3,000 psi. After being held in the preforming tool under pressure and with increased temperature for a preforming time of about 1 minute to about 10 minutes, a ceramic preform has been formed and may be removed from the preforming tool. This green ceramic preform is then fired (step 206) to burn out and exhaust the organic components present in the green ceramic preform to create a fired ceramic preform. The firing step 206 also forms a high-temperature bond between the ceramic particles and reinforcing fibers that have been exposed to the high temperature of the firing process. The construction of the preform is such that when the organic components are burned out, voids remain in the fired ceramic preform where the organic components once were. After firing, the ceramic preform is placed into a squeeze casting mold (step 208). Once one or more ceramic preforms and an optional inorganic casting core are located in the squeeze casting mold, a porous ceramic insert is formed. Next, the squeeze casting mold containing the porous ceramic insert is filled (step 210) with a molten casting alloy and pressurized up to a forming or casting pressure of about 8,000 psi to about 14,000 psi for a forming or casting time of about 20 seconds to about 2 minutes to form a cast MMC braking component. After forming, the cast MMC braking component is removed from the casting mold (step 212). Lastly, the cast MMC braking component is machined (step 214) to final dimensions in one or more machining operations to enhance the performance of the MMC braking component.

Referring now to FIG. 4, the steps of a method 300 of forming an exemplary MMC braking component using a ceramic and molten metal solution, or slurry, are shown. The method 300 begins with forming a suspended ceramic particle and molten metal alloy solution (step 302). In order to form the ceramic particle and molten metal alloy solution, a casting alloy is taken above its melting temperature and a ceramic particle, such as one of silicon carbide, alumina, and zirconia, is added to the molten metal alloy, thereby forming a ceramic particle and molten metal alloy solution. Next, the solution is agitated (step 304) to ensure a homogenous disbursement of ceramic particles in the solution as the ceramic particles typically have a higher density than the molten metal casting alloy and will tend to settle unless agitated or stirred. A squeeze casting mold is filled (step 306) with the homogenous ceramic particle and molten metal solution. The squeeze casting mold is then closed to form a mold cavity that is pressurized (step 308) to a forming pressure of about 8,000 psi to about 14,000 psi for a forming time of about 20 seconds to about 2 minutes during step 308. After pressurization, the mold halves are separated and the formed MMC insert is removed from the squeeze casting mold. Following the creation of one or more MMC inserts, the one or more MMC inserts are inserted in a second squeeze casting tool (step 310) so that they are separated from each other by a spacing distance. The second squeeze casting tool is closed to form a mold cavity and the mold cavity is filled (step 312) with molten metal casting alloy that is pressurized to a forming pressure of about 8,000 psi to about 14,000 psi for a forming time of about 20 seconds to about 2 minutes. After the mold is held under a forming pressure for a forming time, both halves of the second squeeze casting mold are separated and a cast MMC braking component is removed from the second casting mold (step 314). The cast MMC braking component is then machined (step 316) during one or more machining operations to the final dimensions to enhance the performance of the MMC braking component.

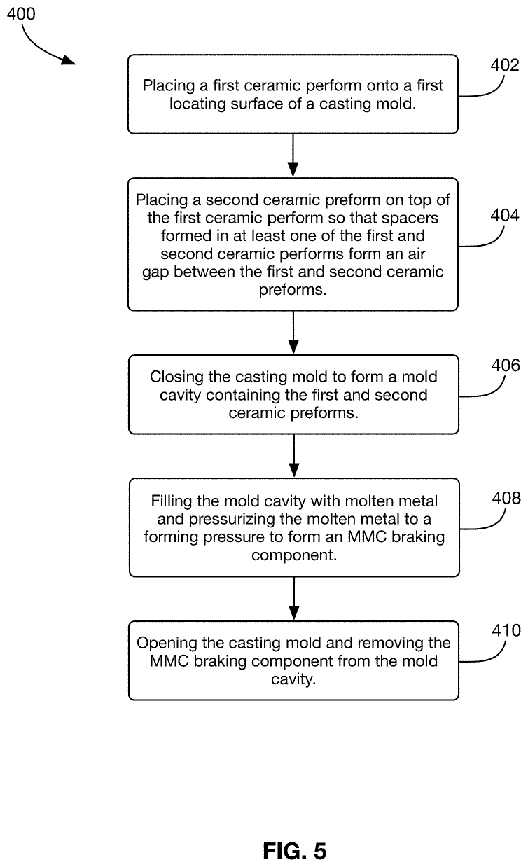

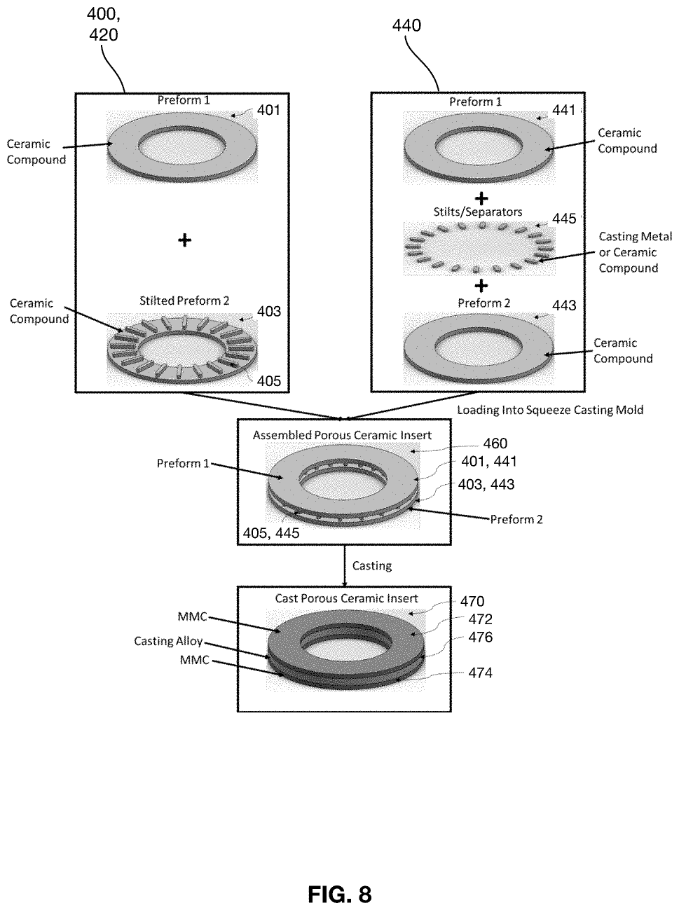

Referring now to FIGS. 5-8, exemplary methods are shown for forming ceramic preforms and for casting MMC braking components where two ceramic preforms are spaced apart to form a thermal management portion between two MMC portions. In particular, FIGS. 5-7 show the steps of exemplary methods of making a ceramic preform or MMC braking component while FIG. 8 includes illustrations of some of the method steps described by flow charts in FIGS. 5-7. A ceramic compound such as the ceramic compound detailed above is used in each of the methods of FIGS. 5-8.

Referring now to FIGS. 5 and 8, a method 400 is shown for forming a cast MMC braking component having a thermal management portion between two MMC wear or friction portions. In the casting process 400 a first ceramic preform 401 is placed onto a first locating surface of a casting mold (step 402). A second ceramic preform 403 is then placed on top of the first ceramic preform (step 404) to form a porous ceramic insert 460. Spacers 405 integrally formed in at least one of the first and second ceramic preforms 401, 403 maintain the second ceramic preform 403 at a spacing distance from the first ceramic preform 401. The integral spacers 405 can be shaped like stilts that vertically support one or both of the ceramic preforms 401, 403. The integral spacers 405 can also include an inclined portion so that rotation of one of the ceramic preforms 401, 403 adjusts the spacing distance between the first and second ceramic preforms 401, 403. The casting mold is closed around the porous ceramic insert 460 (step 406) and is then filled with molten metal and pressurized to a forming pressure (step 408). Lastly, the cast MMC braking component 470 is removed from the casting mold (step 410) and can be machined to final dimensions in one or more machining operations to enhance the performance of the MMC braking component. As can be seen in FIG. 8, the cast MMC braking component includes a first MMC wear or friction surface 472, a second MMC wear or friction surface 474, and a thermal management portion 476 sandwiched between the first and second wear or friction surfaces 472, 474 that is formed of monolithic casting alloy.

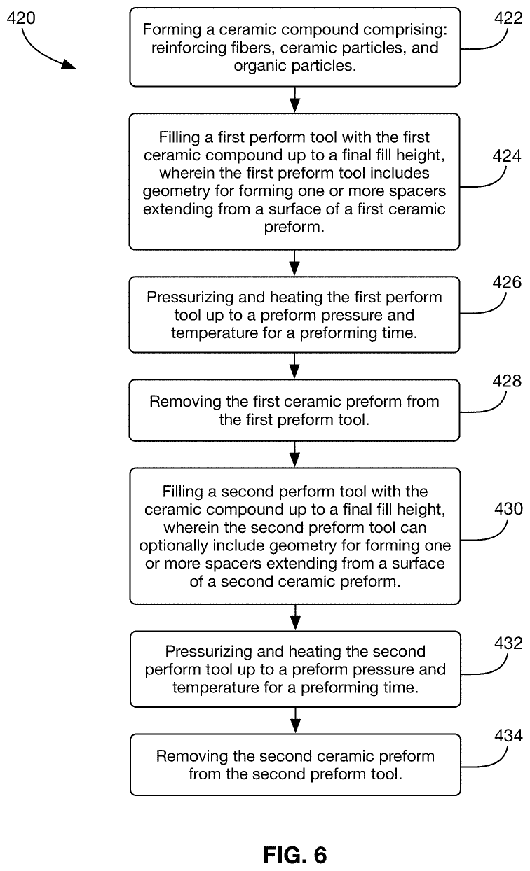

Referring now to FIG. 6, an exemplary method 420 is shown for forming a ceramic preform that includes one or more integral spacers. A ceramic compound is made by combining (step 422) reinforcing fibers, ceramic particles, and organic particles. The compound is then used to fill (step 424) a first preform tool to a final fill height of, for example, about 0.75 inches to about 1.5 inches. The filled preform tool is pressurized and heated (step 426) to a preform pressure of about 1,000 psi to about 4,000 psi and a preform temperature of about 250° F. to about 350° F. for a preforming time of about 1 minute to about 5 minutes. Next, the first ceramic preform is removed (step 428) from the first preform tool. Similar steps are then preformed with a second preform tool to form a second ceramic preform. That is, the second preform tool is filled with the ceramic compound (step 430), the preform tool is heated and pressurized to the preform temperature and pressure for a preform time (step 432), and the second ceramic preform is removed from the second preform tool (step 434).

The first and second preforms can be formed sequentially, as shown, or simultaneously. Also, the first preform tool can form a flat preform while the second preform tool includes mold portions for forming integrally formed spacers, or vice versa. The first and second preform tools can also be a single preform tool that forms first and second ceramic preforms each including integrally formed spacers so that the first and second preforms are spaced apart from each other when placed in a mold cavity of a casting tool. For example, the spacers can include opposing ramp or inclined portion so that when one ceramic preform is rotated relative to the other ceramic preform the distance between the ceramic preforms is increased or decreased.

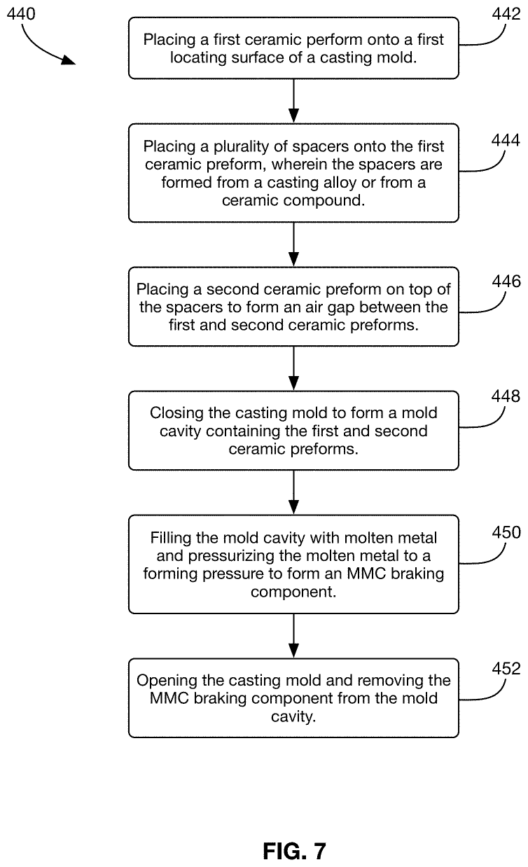

While a space can be formed between two ceramic preforms in a casting mold by virtue of spacers integrated into the ceramic preforms, a space can also be formed during the casting process by the addition of spacers to the casting mold as is described an exemplary method 440, the steps of which are detailed in FIG. 7 and illustrated in FIG. 8. In the method 440, a first ceramic preform 441 is placed on a first locating surface of a casting mold (step 442) and a plurality of spacers 445 are placed on top of the first ceramic preform (step 444). The spacers 445 can be formed from the ceramic compound or can be formed from the casting alloy. Spacers 445 formed from the ceramic compound are impregnated with metal during the casting process to form MMC spacers, while spacers 445 formed from casting alloy are consumed during the casting process and become part of the monolithic portion of casting alloy forming the thermal management portion of the MMC braking component.

After the spacers 445 have been placed in the casting mold, a second ceramic preform 443 is placed on top of the spacers (step 446) to form the porous ceramic insert 460 with an air gap between the first and second ceramic preforms. The casting mold is closed (step 448) to form a mold cavity containing the first and second ceramic preforms and the spacers. The mold cavity is filled (step 450) with molten casting metal and pressured and heated to form an MMC braking component. During casting, the mold cavity molten casting alloy is pressured up to a forming or casting pressure of about 8,000 psi to about 14,000 psi for a forming or casting time of about 20 seconds to about 2 minutes to form a cast MMC braking component. After forming, the cast MMC braking component is removed from the casting mold (step 452) and is machined to final dimensions in one or more machining operations to enhance the performance of the MMC braking component. The resulting cast MMC braking component 470 is described above and shown in FIG. 8.

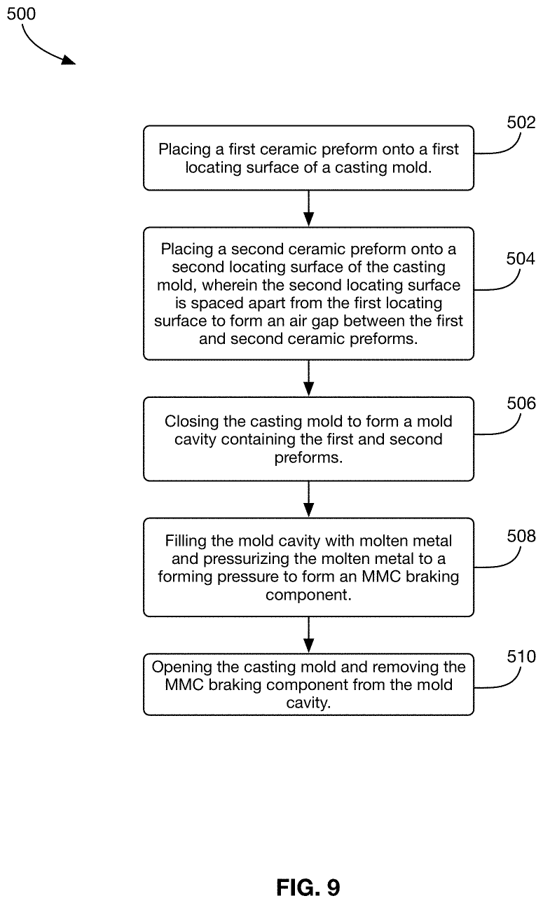

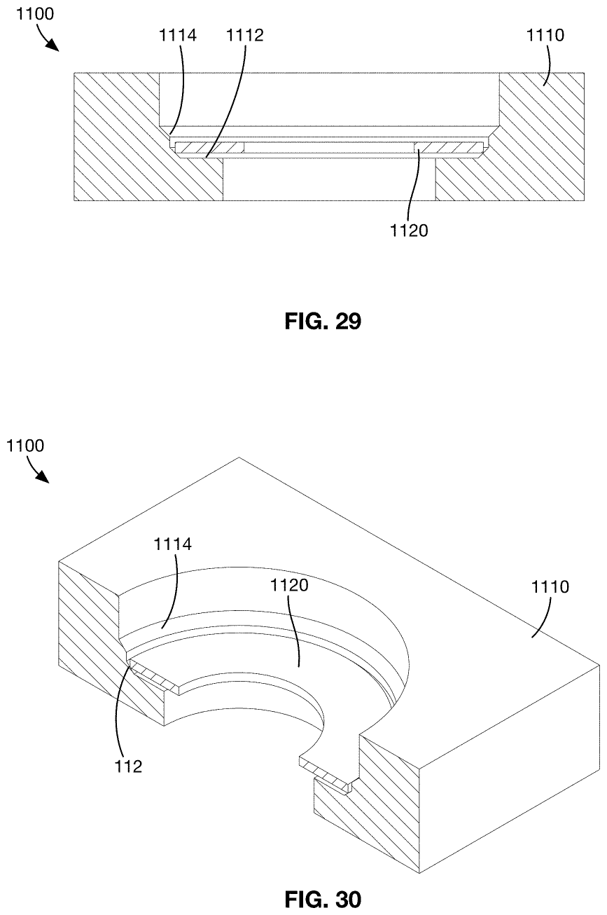

Referring now to FIG. 9, an exemplary method 500 is shown for forming a cast MMC braking component having a thermal management portion between two MMC wear or friction portions. The method 500 is similar to the methods 400, 420, and 440 described above except that spacers are not used to create a distance between two ceramic preforms. Rather, a casting mold is used that includes first and second locating surfaces that are spaced apart. (FIGS. 29-40.) That is, a first ceramic preform is placed onto the first locating surface of the casting mold (step 502) and a second ceramic preform is placed onto the second locating surface of the casting mold (504). The spacing of the first and second locating surfaces creates a gap between the first and second ceramic preforms so that when the mold is closed (step 506) and filled with molten casting alloy (step 508) the resulting MMC braking component includes a monolithic portion of casting metal between two MMC wear or friction portions when the MMC braking component is removed from the casting mold (step 510).

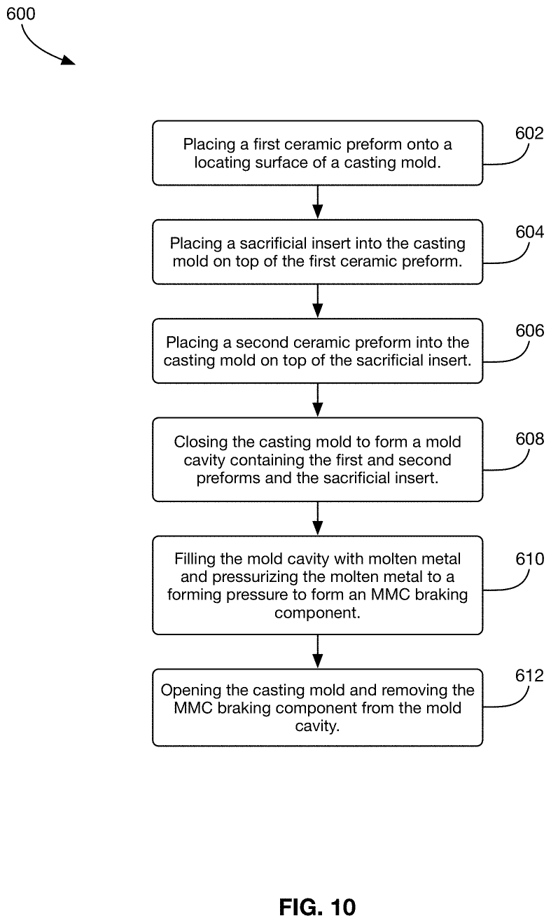

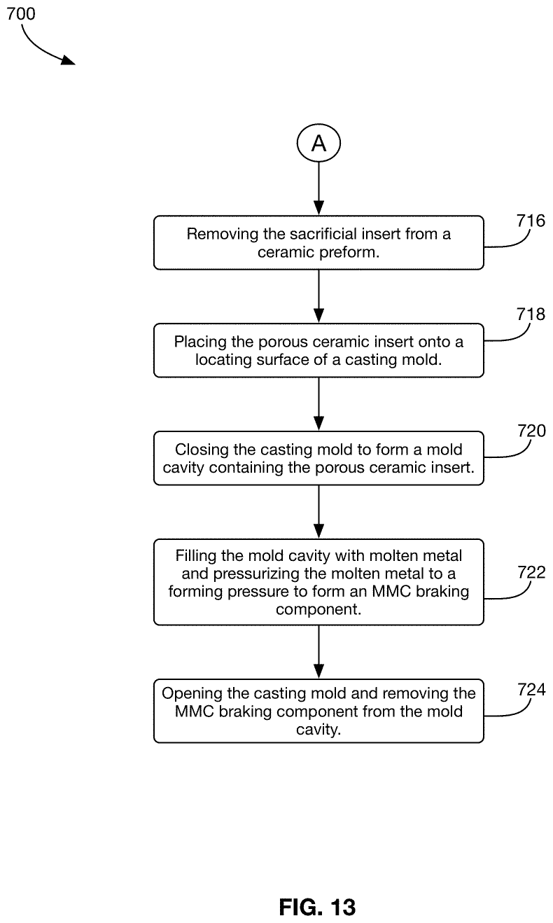

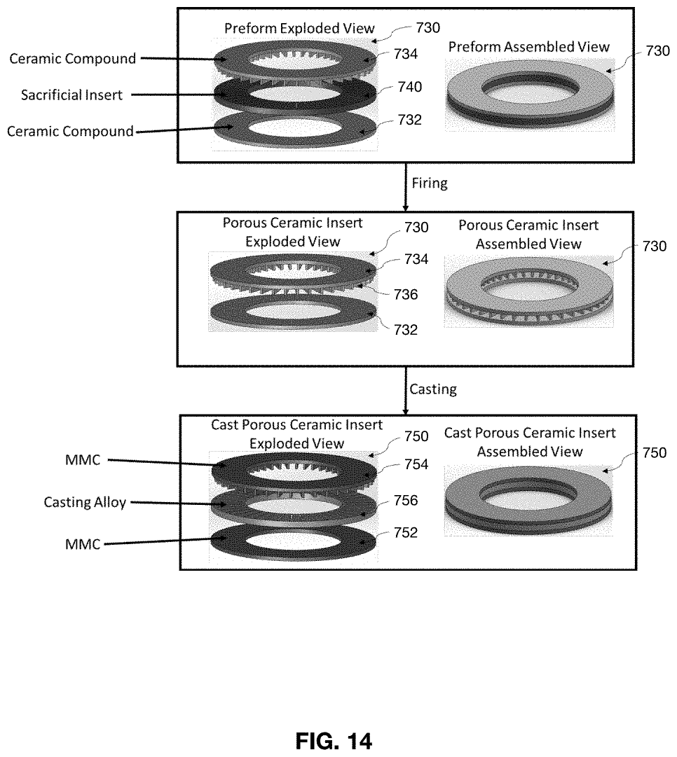

Referring now to FIGS. 10-21, exemplary methods are shown for forming ceramic preforms and for casting MMC braking components where two ceramic preforms are spaced apart to form a thermal management portion between two MMC portions. The exemplary methods, ceramic preforms, and MMC braking components shown in FIGS. 10-21 use sacrificial materials—i.e., materials that are consumed during the preform or casting processes—to form a space or gap between two ceramic preforms to form the thermal management portion of the resulting MMC braking component.

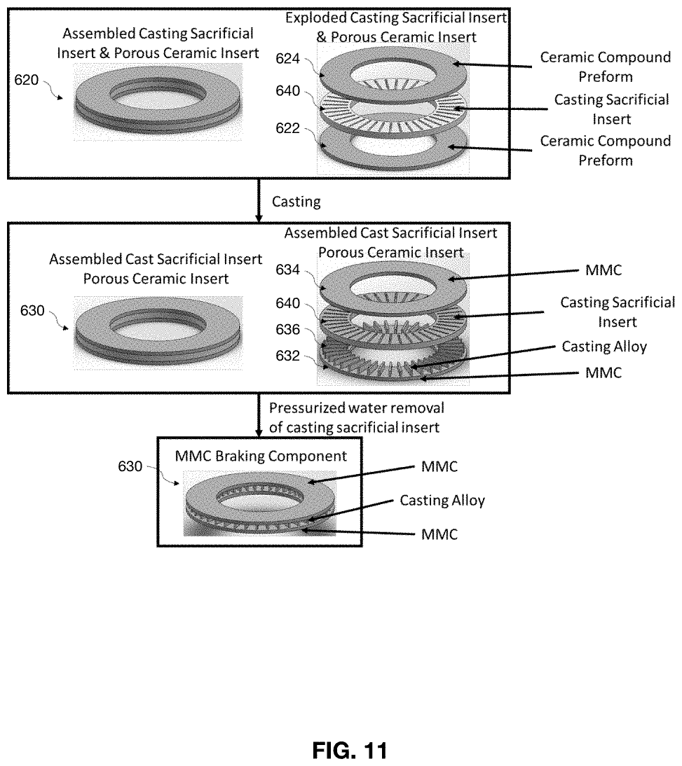

Referring now to FIGS. 10 and 11, an exemplary method 600 is shown for forming a cast MMC braking component having a thermal management portion between two MMC wear or friction portions. Similar to exemplary methods described above, a porous ceramic insert 620 is formed in a casting mold by placing a first ceramic preform 622 onto a locating surface of a casting mold (step 602), placing a non-porous, inorganic sacrificial insert 640 on top of the first ceramic preform (step 604), and placing a second ceramic preform 624 on top of the sacrificial insert 640 (step 606). Thus, the first and second ceramic preforms 622, 624 are spaced apart by the sacrificial insert 640. The sacrificial insert 640 includes voids or openings that create gaps or spaces between the first and second preforms 622, 624 so that when the mold is closed (step 608) and filled with molten casting alloy (step 610) the resulting MMC braking component 630 includes monolithic portions of casting metal 636 between two MMC wear or friction portions 632, 634 when the MMC braking component 630 is removed from the casting mold (step 612). During casting, the molten casting alloy is pressured up to a forming or casting pressure of about 8,000 psi to about 14,000 psi for a forming or casting time of about 20 seconds to about 2 minutes to form a cast MMC braking component. The sacrificial insert 640 can be removed during the casting step or can be removed after the casting step with pressurized water or via heating or firing of the MMC braking component 630. After the entirety of the sacrificial casting insert has been removed, the result is an MMC vehicle braking component 630 with a plurality of casting alloy stilts 636 integrally formed with the MMC portions 632 and 634. Due to the integral formation of the stilts 636 with the MMC portions 632, 634, a vented thermal management portion is formed. After forming, the cast MMC braking component can be machined to final dimensions in one or more machining operations to enhance the performance of the MMC braking component.

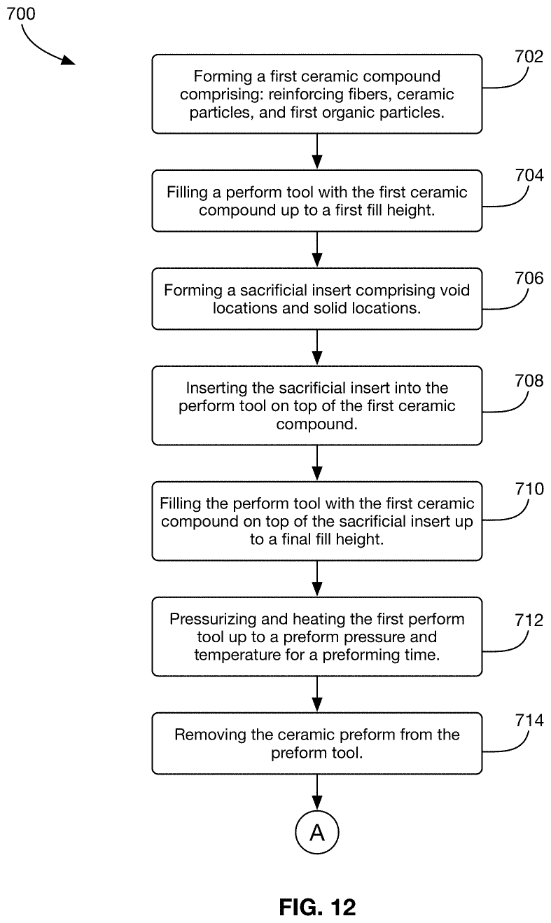

Referring now to FIGS. 12-14, an exemplary method 700 is shown for forming a cast MMC braking component having a thermal management portion between two MMC wear or friction portions. A ceramic compound including reinforcing fibers, ceramic particles, and first organic particles is formed (step 702) and used to fill (step 704) a preform tool to a first fill height, such as, for example, about 0.75 inches to about 2.0 inches, thereby forming a first layer 732 of ceramic compound. A sacrificial insert 740 including void locations and solid locations is formed (step 706) and placed in the preform tool on top of the first layer of ceramic compound 732 (step 708). The preform tool is filled (step 710) again with the ceramic compound to a final fill height of, for example, about 0.75 inches to about 2.0 inches to form a second layer of ceramic compound 734 that covers the sacrificial insert 740 and fills the void locations of the sacrificial insert 740. The filled preform tool is pressurized and heated (step 712) to a preform pressure of about 1,000 psi to about 4,000 psi and a preform temperature of about 250° F. to about 350° F. for a preforming time of about 1 minute to about 5 minutes. The ceramic preform is removed (step 714) from the preform tool and fired to remove the sacrificial insert (step 716) to form a porous ceramic insert 730. The porous ceramic insert is placed (step 718) onto a locating surface of a casting mold which is closed (step 720) to form a mold cavity including the porous ceramic insert 730. The mold cavity is filled (step 722) with molten casting alloy and is pressured up to a forming or casting pressure of about 8,000 psi to about 14,000 psi for a forming or casting time of about 20 seconds to about 2 minutes to form a cast MMC braking component. After forming, the cast MMC braking component is removed from the casting mold (step 724) and is machined to final dimensions in one or more machining operations to enhance the performance of the MMC braking component.

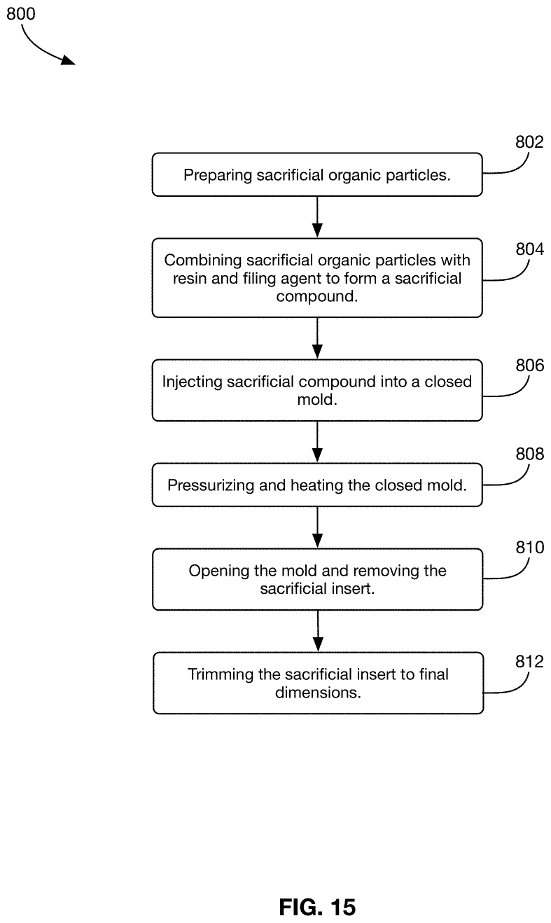

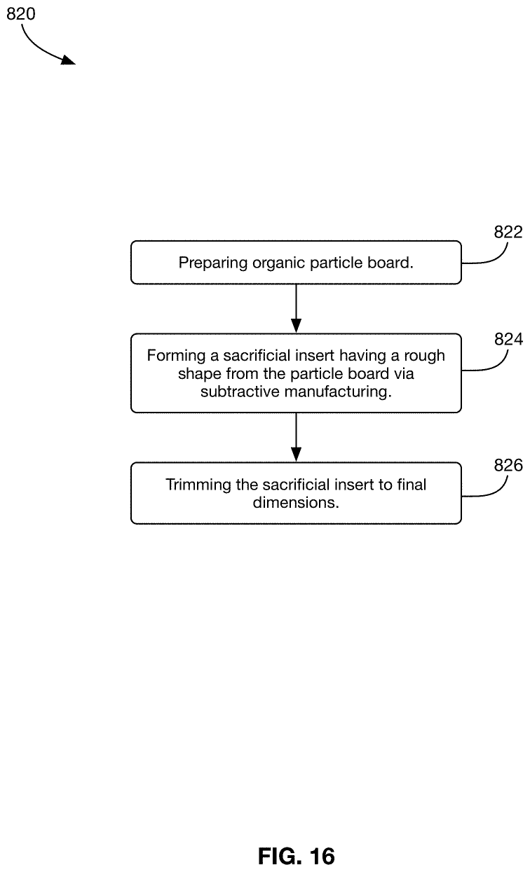

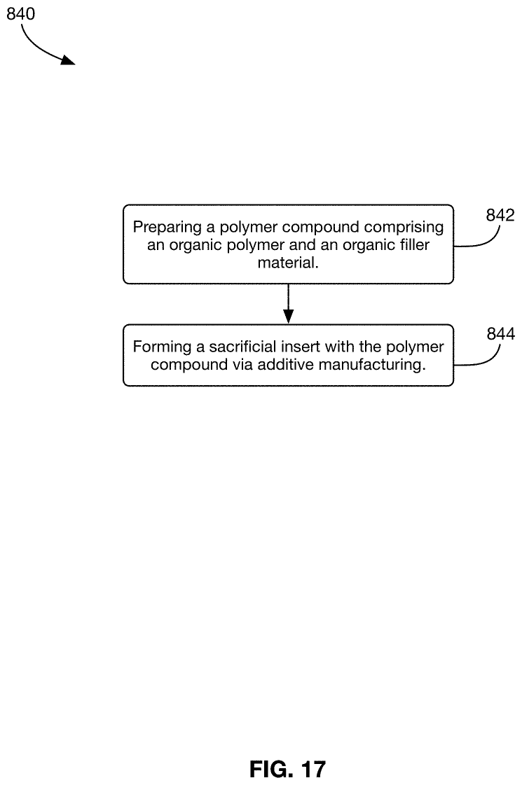

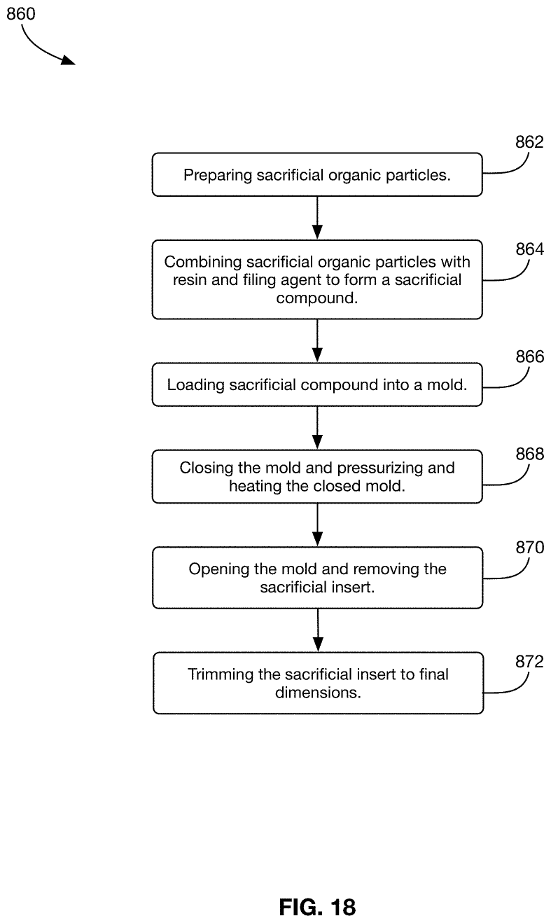

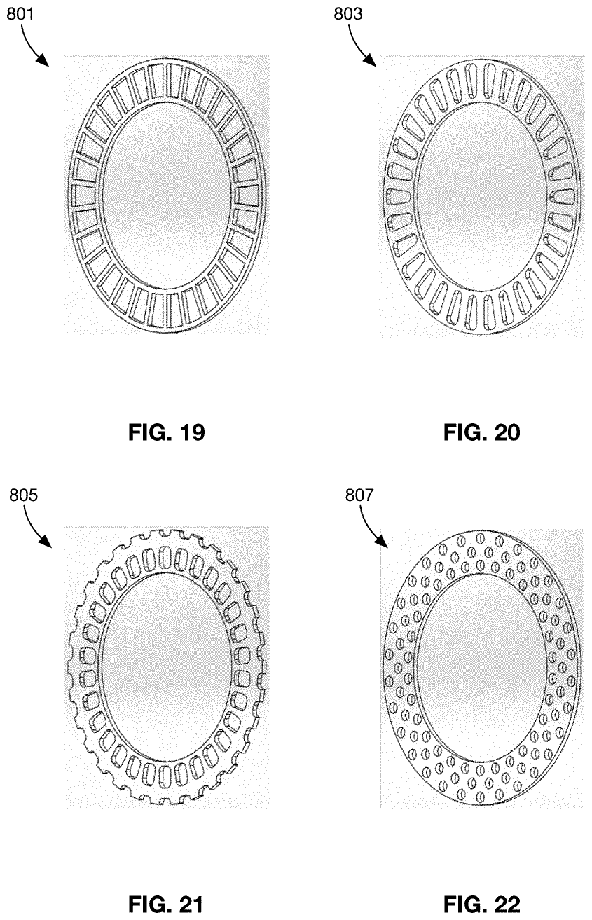

Referring now to FIGS. 15-22, exemplary methods of forming sacrificial inserts (e.g., sacrificial inserts 640 and 740) for use in processes, such as, for example, the methods 600 and 700 described above. Sacrificial inserts can be formed in a wide variety of ways, such as, for example, by injection molding (FIG. 15), compression molding (FIG. 18), subtractive manufacturing (FIG. 16), and additive manufacturing (FIG. 17). As can be seen in FIGS. 19-22, sacrificial inserts 801, 803, 805, and 807 are shown to illustrate that sacrificial inserts can be formed into a wide variety of shapes depending on the desired thermal properties of the thermal management portion of the MMC braking component. The sacrificial inserts 801, 803, 805, 807 all include void or open portions and solid portions. During casting or preforming, the void or open portions are filled with ceramic compound or casting metal alloy and the solid portions remain intact so that when the sacrificial insert is removed, the material filling the void portions remains.

Referring now to FIG. 15, an exemplary method of forming a sacrificial insert via injection molding is shown. Sacrificial organic particles are prepared (step 802), combined (step 804) with resin and a filling agent to form a sacrificial compound, injected (step 806) into a closed mold, pressurized and heated (step 808) until the sacrificial insert is formed and can be removed from the mold to be trimmed (step 812) to final dimensions. The sacrificial compound being comprised of: about 75 wt. % to about 85 wt. % sacrificial organic particles, about 5 wt. % to about 10 wt. % resin, and about 5 wt. % to about 15 wt. % organic filling agent. After injection with the sacrificial compound, the closed mold is pressurized to a molding pressure of about 1,000 psi to about 3,000 psi and heated to a molding temperature of about 200° F. to about 300° F. for about 30 seconds to about 3 minutes. The sacrificial insert is then removed from the injection molding tool.

Referring now to FIG. 18, an exemplary method of forming a sacrificial insert via compression molding is shown. Sacrificial organic particles are prepared (step 862), combined (step 864) with resin and a filling agent to form a sacrificial compound, loaded (step 866) into a mold, pressurized and heated (step 868) until the sacrificial insert is formed and can be removed from the mold to be trimmed (step 872) to final dimensions. The sacrificial compound being comprised of: about 75 wt. % to about 85 wt. % sacrificial organic particles, about 5 wt. % to about 10 wt. % resin, and about 5 wt. % to about 15 wt. % organic filling agent. After injection with the sacrificial compound, the closed mold is pressurized to a molding pressure of about 1,000 psi to about 3,000 psi and heated to a molding temperature of about 200° F. to about 300° F. for about 30 seconds to about 3 minutes. The sacrificial insert is then removed from the molding tool.

Referring now to FIG. 16, an exemplary method 820 of forming a sacrificial insert via subtractive manufacturing is shown. An organic particle board is prepared (step 822) and then formed (step 824) into a rough shape via subtractive manufacturing techniques, such as, for example, die cutting, milling, or laser cutting. The rough shape is then trimmed (step 826) to a final dimension. Additive manufacturing can also be used to form the sacrificial insert, as is shown in the exemplary method 840 of FIG. 17, in which a sacrificial polymer compound is prepared (step 842) and then used to form the sacrificial insert via additive manufacturing (step 844). The sacrificial polymer compound is made from about 60 wt. % to 80 wt. % organic polymer and about 40 wt. % to about 20 wt. % organic filler.

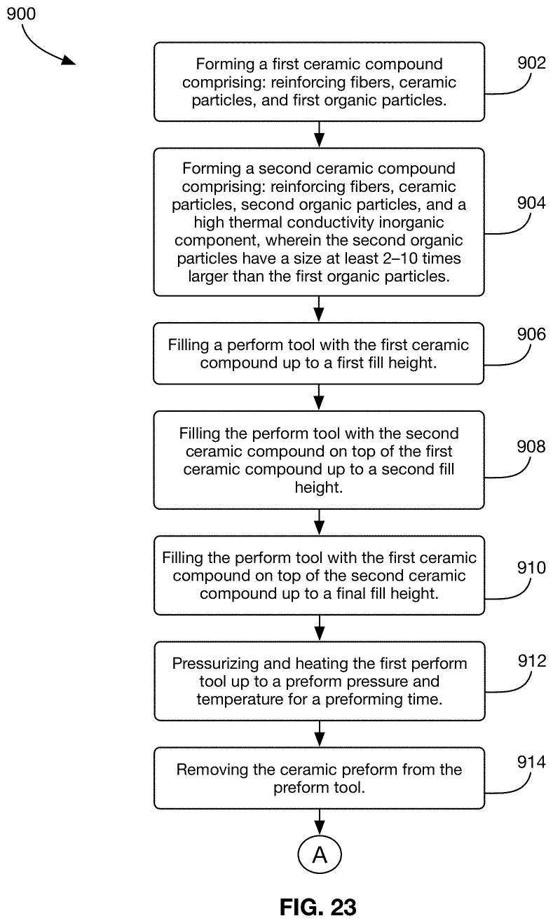

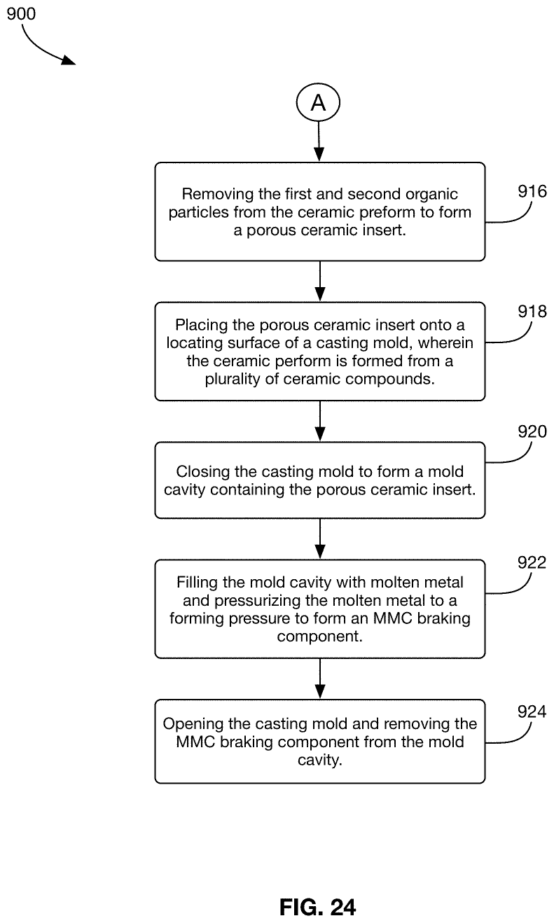

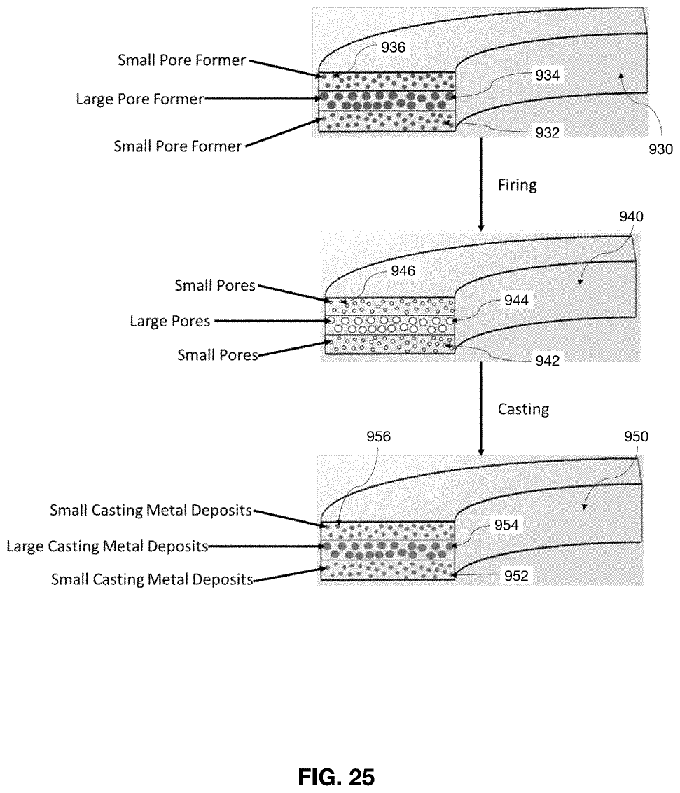

Referring now to FIGS. 23-25, an exemplary method 900 is shown for forming a cast MMC braking component having a thermal management portion between two MMC wear or friction portions. A first ceramic compound including reinforcing fibers, ceramic particles, and first organic particles is formed (step 902) and used to fill (step 906) a preform tool to a first fill height, such as, for example, about 0.75 inches to about 1.5 inches, thereby forming a first layer 932 of ceramic compound. A second ceramic compound including reinforcing fibers, ceramic particles, and second organic particles is formed (step 904) and is used to fill (step 908) the preform tool on top of the first ceramic compound up to a second fill height, such as, for example, about 1.25 inches to about 2.0 inches to form a second layer 934. The preform tool is then filled (step 910) to a final fill height, such as, for example, about 0.75 inches to about 1.5 inches, with the first ceramic compound to form a third layer 936 of ceramic compound. The filled preform tool is pressurized and heated (step 912) to a preform pressure of about 1,000 psi to about 4,000 psi and a preform temperature of about 250° F. to about 350° F. for a preforming time of about 1 minute to about 5 minutes. The ceramic preform is removed (step 914) from the preform tool and fired to remove the first and second organic particles (step 916) to form a porous ceramic insert 940. The porous ceramic insert 940 is placed (step 918) onto a locating surface of a casting mold which is closed (step 920) to form a mold cavity including the porous ceramic insert 940. The mold cavity is filled (step 922) with molten casting alloy and is pressured up to a forming or casting pressure of about 8,000 psi to about 14,000 psi for a forming or casting time of about 20 seconds to about 2 minutes to form a cast MMC braking component. After forming, the cast MMC braking component is removed from the casting mold (step 924) and is machined to final dimensions in one or more machining operations to enhance the performance of the MMC braking component.

The second organic particles of the second ceramic compound have a size that is at least double, or at least five times, or at least ten times the size of the first organic particles size of the first ceramic compound so that when the first and second organic particles are removed from the ceramic preform via firing, the voids or pores left behind are larger in the second layer of the porous casting insert. Using a large pore former—i.e., sacrificial organic particle—increases the porosity of the second or middle layer of the preform providing two benefits: (1) facilitating better metal flow during infiltration; and (2) facilitating the flow of more casting metal alloy into the larger pores during casting. The increased proportion of casting alloy to MMC in the thermal management portion increases the thermal conductivity and heat capacity of the thermal management portion.

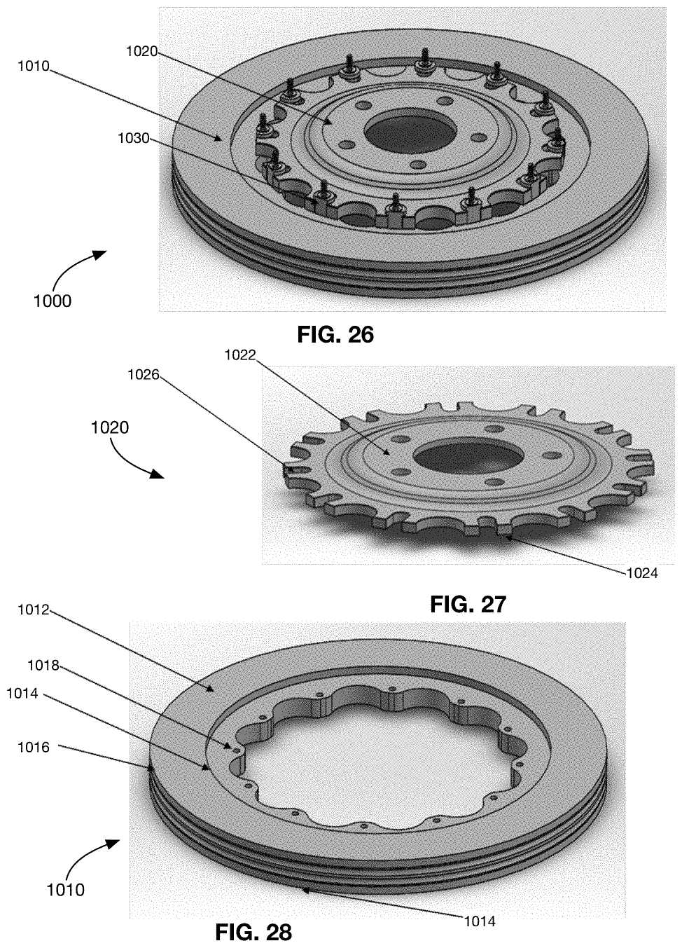

Referring now to FIGS. 26-28, an exemplary two-piece braking assembly 1000 is shown. The two-piece braking assembly includes a disc 1010 and a hub 1020. The disc 1010 can be composed of entirely MMC material while the hub 1020 can be substantially free of MMC material and can be composed of monolithic casting alloy. The disc 1010 is attached to the hub 1020 by way a plurality of fasteners 1030. Anywhere from three to eighteen or to thirty fasteners 1030 can be used to join the disc 1010 and the hub 1020. The fasteners 1030 can be any suitable fastener, such as, for example, bobbins, bolts, clips, rivets, or clasps.

Referring now to FIG. 27, the hub 1020 of the two-piece MMC braking component 1000 is shown. The hub 1020 includes a hub mounting portion 1022 that attaches directly to a vehicle (not shown) via bolts fastened through holes in the hub mounting portion 1022. The hub 1020 also includes a disc mounting portion 1024 that attaches to the disc 1010 via the fasteners 1030 shown in FIG. 26. The thickness of the hub 1020 can be measured between the hub mounting portion 1022 and the disc mounting portion 1024 and can be about 0.125 inches to about 3 inches. A plurality of fastening locations 1026 are radially spaced apart in the disc mounting portion 1024. The fastening locations 1026 can have any suitable shape that allows movement of the fasteners 1030 relative to the hub 1020, such as, for example, the radially oriented open slots shown in FIG. 27. That is, the slot-to-fastener connection allows for radial relative movement between the hub 1020 and disc 1010 while maintaining a rotational coupling between the hub 1020 and disc 1010.

Referring now to FIG. 28, the disc 1010 of the two-piece MMC braking component 1000 is shown. In contrast to the hub 1020 which is substantially free of MMC, the disc can be entirely formed from MMC material. The disc 1010 has a generally ring-like shape extending between a first friction surface 1012 and a second friction surface 1014. The first friction surface 1012 and the second friction surface 1014 each extend from an inner diameter 1016 to an outer diameter 1018. The inner diameter 1016 ranges from about 6 inches to about 16 inches and the outer diameter 1018 ranges from about 8 inches to about 18 inches. A thickness of the disc 1010 between the first friction surface 1012 and the second friction surface 1014 is about 0.125 to about 1.5 inches. A plurality of fastening locations 1018 are arranged inside the inner diameter 1016 of the disc 1010 and correspond to the fastening locations 1026 of the hub 1020. Fasteners 1030 (FIG. 26) extend from the fastening locations 1018 of the disc 1010 to the fastening locations 1026 of the hub to connect the disc 1010 and hub 1020.

During a breaking event, large amounts of kinetic energy are converted into heat via friction with the disc 1010. To increase the brake torque for a specific application, it is common to increase the diameter of a brake disc so there is a greater braking torque applied than that of a brake disc with a smaller diameter. Another effect of increasing the diameter of the brake disc is that the thermal mass of the disc increases. More thermal mass results in increased stresses in the disc because of radial thermal expansion during heating. As the diameter of the brake disc increases in a single piece assembly, the stress from thermal expansion at the connection point between the hub and disc portion of the brake assembly may eclipse the yield stress of a lightweight casting alloy such as aluminum. The exemplary two-piece assembly of the present disclosure reduces or eliminates the transmission of stress from thermal expansion of the brake disc to the brake hub. That is, the disc 1010 can expand radially from thermal expansion without transmitting radial forces to the hub 1020 because the fasteners 1030 are allowed to slide within the slots at the fastening locations 1026 of the hub 1020 while torque or moment forces are transmitted via the fasteners 1030 from the disc 1010 to the hub 1020 to facilitate braking. While the fasteners 1030 are shown arranged on one side of the disc 1010 in FIG. 26, sliding connections similar to those shown in FIGS. 26-28 can be arranged internal to the hub 1020 or disc 1010. Also, the fasteners 1030 can be integrally formed with either or both of the hub 1020 and the disc 1010.

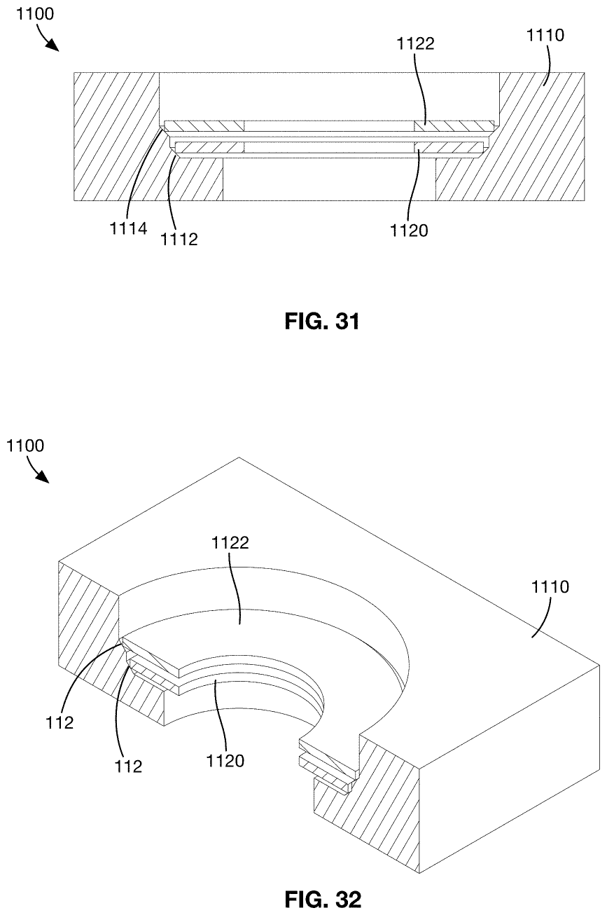

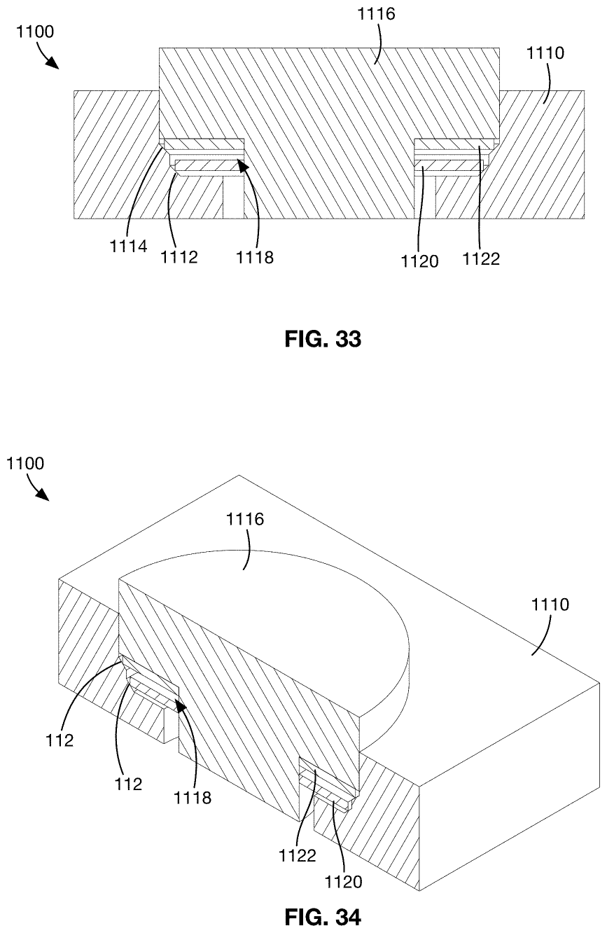

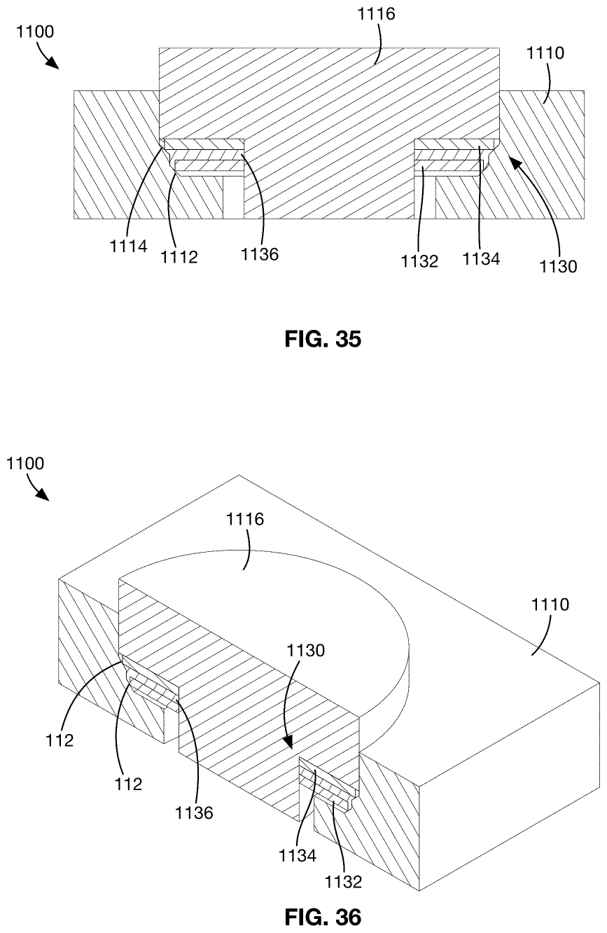

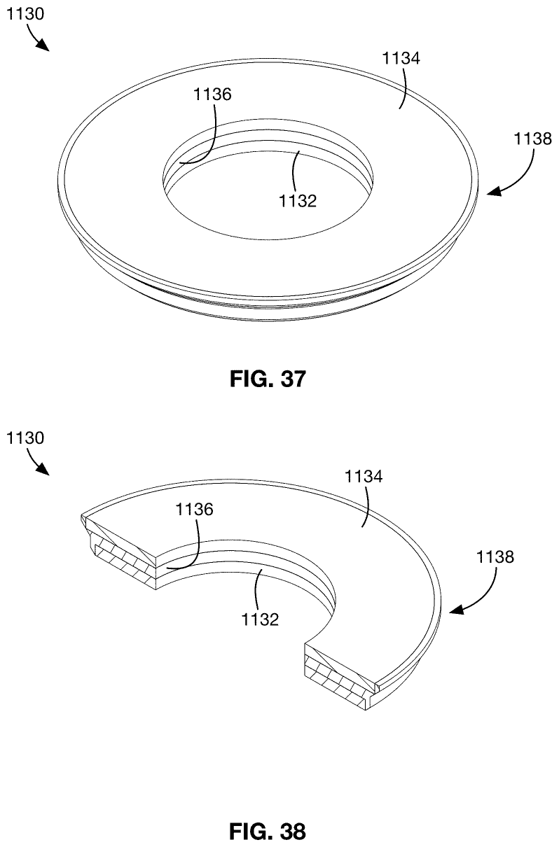

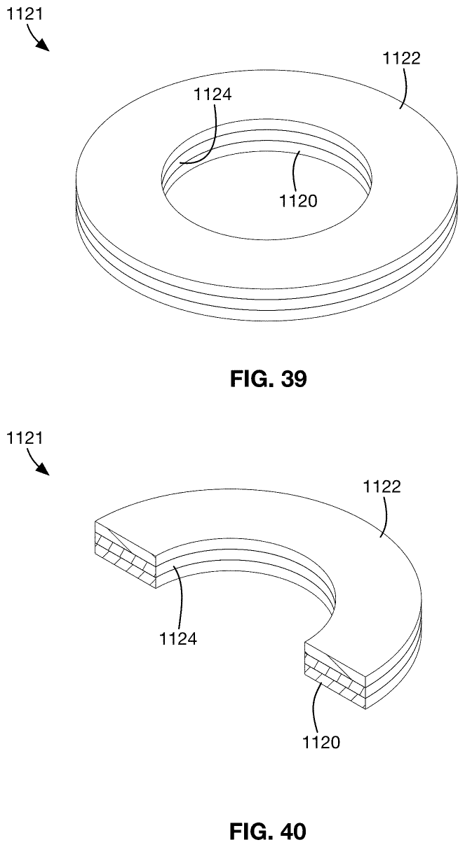

Referring now to FIGS. 29-40, the steps of the process 500 shown in FIG. 9 and described above are shown. As can be seen in FIGS. 29-36, an exemplary mold 1100 includes a female die 1110 and a male die 1116. The female die 1110 includes a first locating surface 1112 and a second locating surface 1114. To form a cast braking component, the mold 1100 is opened and a first ceramic preform 1120 is placed on the first locating surface 1112. (FIGS. 29-30; see also step 502 of FIG. 9.) A second ceramic preform 1122 is then placed on the second locating surface 1114 (FIGS. 31-32; see also step 504 of FIG. 9) before the mold 1100 is closed by the male die 1116 to form a gap 1118 between the first ceramic preform 1120 and the second ceramic preform 1122 (FIGS. 33-34; see also step 506 of FIG. 9). The second ceramic preform 1122 can have a larger diameter than the first ceramic preform 1120 so that the second ceramic preform 1122 rests on the second locating surface 1114 that has larger diameter than the first locating surface 1112. The gap 1118 is filled when molten casting alloy is injected into the mold 1100 to form an exemplary MMC braking component 1130. (FIGS. 35-36; see also step 508 of FIG. 9.) As is shown in FIGS. 35-40, the MMC braking component 1130 includes a first MMC portion 1132 spaced apart from a second MMC portion 1134 by a thermal management portion 1136. When the MMC braking component 1130 is first removed from the mold (FIGS. 37-38; see also step 510 of FIG. 9), the MMC braking component 1130 includes excess material 1138 that can be both casting alloy and MMC (for example, as a result of the larger diameter of the second ceramic preform 1122). The MMC braking component 1130 is machined to remove the excess material 1138 to reach the final dimensions shown in FIGS. 39-40.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, alternatives as to form, fit, and function, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein.

Additionally, even though some features, concepts, or aspects of the disclosures may be described herein as being a preferred arrangement or method, such description is not intended to suggest that such feature is required or necessary unless expressly so stated. Still further, exemplary or representative values and ranges may be included to assist in understanding the present application, however, such values and ranges are not to be construed in a limiting sense and are intended to be critical values or ranges only if so expressly stated.

Moreover, while various aspects, features and concepts may be expressly identified herein as being inventive or forming part of a disclosure, such identification is not intended to be exclusive, but rather there may be inventive aspects, concepts, and features that are fully described herein without being expressly identified as such or as part of a specific disclosure, the disclosures instead being set forth in the appended claims. Descriptions of exemplary methods or processes are not limited to inclusion of all steps as being required in all cases, nor is the order that the steps are presented to be construed as required or necessary unless expressly so stated. The words used in the claims have their full ordinary meanings and are not limited in any way by the description of the embodiments in the specification.

What is claimed is:

1. A metal matrix composite (MMC) braking component comprising:
a single cast part at least partially formed as a disc, the casting comprising a first MMC portion, a second MMC portion, and a thermal management portion, wherein the thermal management portion is substantially free from ceramic particles; and
a hub attached to at least one of the first MMC preform portion, the second MMC preform portion, and the thermal management portion.

2. The MMC braking component of claim 1, wherein the single cast part comprises the hub.

3. The MMC braking component of claim 1, wherein the thermal management portion comprises greater than 80 percent by weight of a casting alloy used to form the MMC braking component.

4. The MMC braking component of claim 1, wherein the thermal management portion comprises casting alloy portions that are substantially free from ceramic particles.

5. The MMC braking component of claim 4, wherein the casting alloy portions having a substantially spherical shape and are encapsulated by an MMC material.

6. The MMC braking component of claim 1, wherein the hub is substantially free from ceramic particles.

7. The MMC braking component of claim 1, wherein the hub is connected to the disc such that the transmission of rotational forces is promoted and the transmission of radial forces is prohibited.

8. The MMC braking component of claim 1, wherein the hub and the disc are connected by a plurality of fasteners.

9. The MMC braking component of claim 8, wherein: the plurality of fasteners are attached to the disc; and the hub comprises a plurality of slots for receiving the plurality of fasteners.

10. The MMC braking component of claim 1, wherein:
an outer diameter of the disc ranges from about 8 inches to about 18 inches;
an inner diameter of the disc is about 6 inches to about 16 inches;
a thickness of the disc is about 0.125 inches to about 1.5 inches; and
a thickness ratio of the first and second MMC portions to the thermal management portion is about 1:3 to about 3:1.

11. The MMC braking component of claim 1, wherein the thermal management portion of the disc has a thickness of about 0.4 inches and each of the first MMC portion and the second MMC portion have a thickness of about 0.25 inches.

12. A method of making a metal matrix composite (MMC) braking component comprising:
placing a first ceramic preform on a first locating surface of a casting mold;
placing a second ceramic preform on a second locating surface, wherein the second locating surface is spaced apart from the first locating surface to form a gap between the first and second ceramic preforms;
closing the mold to form a mold cavity, the first and second the ceramic preforms being disposed within the mold cavity;
providing molten metal casting alloy into the mold cavity; and
pressurizing and heating the mold to a casting pressure at a casting temperature for a casting duration to infiltrate the ceramic preform thereby forming the MMC braking component.

13. The method of claim 12, wherein the second locating surface is integrally formed in the casting mold.

14. The method of claim 12, further comprising:
placing a spacing member onto the first ceramic perform to create the second locating surface.

15. The method of claim 14, wherein the spacing member is formed from a metal alloy.

16. The method of claim 15, wherein the metal alloy of the spacing member is the same as the molten metal casting alloy.

17. The method of claim 14, wherein the spacing member is integrally formed with one of the first ceramic preform and the second ceramic preform.

18. The method of claim 14, wherein the spacing member comprises a sacrificial insert.

19. The method of claim 14, wherein the spacing member comprises a non-porous inorganic insert.

20. The method of claim 14, wherein:
the first and second ceramic preforms are formed from a first ceramic compound; and the spacing member is formed from a second ceramic compound.
